(19) United States
(12) Patent Application Publication
(10) Pub. No.: US 2026/0003341 A1
(43) Pub. Date: Jan. 1, 2026

(54) PLATFORM INTEGRATING CONTEXTUAL DATA FOR SUPERVISORY CONTROL AND DATA ACQUISITION (SCADA)

(71) Applicants: Justin Starr, Nashville, TN (US); Stephen Kemp, Nashville, TN (US); Bryan Mundie, Nashville, TN (US); David Mundie, Nashville, TN (US); ian Parker Hodge, Nashville, TN (US); Eric Winton, Nashville, TN (US); Sarah Beckum, Nashville, TN (US); Antonio Kincaid-Rivadeneyra, Nashville,, TN (US)

(72) Inventors: Justin Starr, Nashville, TN (US); Stephen Kemp, Nashville, TN (US); Bryan Mundie, Nashville, TN (US); David Mundie, Nashville, TN (US); ian Parker Hodge, Nashville, TN (US); Eric Winton, Nashville, TN (US); Sarah Beckum, Nashville, TN (US); Antonio Kincaid-Rivadeneyra, Nashville,, TN (US)

(73) Assignee: High Tide Technologies, LLC, Nashville, TN (US)

(21) Appl. No.: 18/758,726

(22) Filed: Jun. 28, 2024

(51) Int. Cl. G05B 19/4155

(52) U.S. Cl. CPC G05B 19/4155; G05B 2219/32404

(57) ABSTRACT

A method is described for controlling one or more industrial machines based on external contextual data and monitoring data of a supervisory control and data acquisition (SCADA) system. The method includes obtaining, using an application programming interface (API), the external contextual data from one or more external sources. Monitoring data including one or more alarms obtained from one or more remote terminal units (RTUs) associated with the one or more industrial machines is identified. The external contextual data is integrated with the monitoring data to form a combined display of the external contextual data and the monitoring data. Data is provided that visually associates the external contextual data and the one or more alarms in the combined display. Thereafter, a control instruction is communicated to the one or more industrial machines, via the one or more RTUs. The control instruction is configured to change the state of the one or more industrial machines to address the one or more alarms.

### BACKGROUND

Supervisory Control and Data Acquisition (SCADA) systems provide a control architecture for a network of industrial machines and related devices such as switches, pumps or gates, as well as sensors (collectively “industrial machines”). For example, in water and wastewater management collection and treatment systems, a SCADA system may control a variety of industrial machines using a controller in the nature of a programmable logic controller (PLC) that interfaces with an industrial machine such as a water pump, as well as a variety of sensors, such as water level sensors, that are used to collect monitoring data, such as water level, flow rate, device or industrial machine state, and the like.

Conventionally, SCADA systems include one or more controllers or computers that receive monitoring data from sensors and communicate control instructions to the networked industrial machines. One example of a network of devices is a PLC network, with PLCs forming interfaces with industrial machines. In some examples, one or more remote terminal or telemetry units (RTUs) provide an interface to the PLC network, and one or more central controllers, for example a cloud computing device or server, communicate instructions via the one or more RTUs to control the industrial machines.

### BRIEF SUMMARY

One problem that arises around controlling a large and geographically dispersed set of industrial machines is managing events such as alarms or other control-related events. By way of example, a water utility may manage a large set of geographically distributed industrial machines and related equipment or devices, such as water towers, water level sensors, flow sensors, water pumps, valves, etc., associated with water collection and wastewater treatment installations. These industrial machines may be distributed throughout a large geographic area, for example spanning many different municipalities, counties or states. In this circumstance, it is possible to encounter large groups of events, for example alarm conditions reported by sensors, such as high-water level over a threshold. While it is possible to receive monitoring data for all events, it can be unmanageable to ascertain the nature of the events, for example relationship with a geographic location, an external event, etc., given the large number of industrial machines being monitored. For example, it is difficult to identify if a subset of alarm events is anomalous and related to an external event in some way that is actionable, offering greater insight and opportunity to manage these alarm events.

Accordingly, an embodiment integrates contextual data into a SCADA system to permit relation of alarm events based on the contextual data, e.g., indicative of an external event such as a weather event. An embodiment therefore permits an end user to view monitoring data with added context to assist in identifying related alarm events and managing the same. In an embodiment, automations may be produced by virtue of integrating the contextual data with alarm event data, permitting greater control orchestration of a large network of industrial machines.

In summary, an embodiment provides a method for controlling one or more industrial machines based on external contextual data and monitoring data of a supervisory control and data acquisition (SCADA) system, comprising: obtaining, using an application programming interface (API), the external contextual data from one or more external sources; identifying, using a set of one or more processors, monitoring data comprising one or more alarms obtained from one or more remote terminal or terminal units (RTUs) associated with the one or more industrial machines; integrating, using the set of one or more processors, the external contextual data with the monitoring data to form a combined display of the external contextual data and the monitoring data; providing data that visually associates the external contextual data and the one or more alarms in the combined display; and thereafter communicating a control instruction to the one or more industrial machines, via the one or more RTUs, the control instruction configured to change the state of the one or more industrial machines to address the one or more alarms.

Another embodiment provides a system for controlling one or more industrial machines based on external contextual data and monitoring data of a supervisory control and data acquisition (SCADA) system, comprising: a set of one or more processors; and a non-transitory storage medium comprising code executable by the set of one or more processors to: obtain, using an application programming interface (API), the external contextual data from one or more external sources; identify, using the set of one or more processors, monitoring data comprising one or more alarms obtained from one or more remote terminal units (RTUs) associated with the one or more industrial machines; integrate, using the set of one or more processors, the external contextual data with the monitoring data to form a combined display of the external contextual data and the monitoring data; provide data that visually associates the external contextual data and the one or more alarms in the combined display; and thereafter communicate a control instruction to the one or more industrial machines, via the one or more RTUs, the control instruction configured to change the state of the one or more industrial machines to address the one or more alarms.

A further embodiment provides a computer program product for controlling one or more industrial machines based on external contextual data and monitoring data of a supervisory control and data acquisition (SCADA) system, comprising: a non-transitory computer readable medium comprising code executable by a set of one or more processors to: obtain, using an application programming interface (API), the external contextual data from one or more external sources; identify, using the set of one or more processors, monitoring data comprising one or more alarms obtained from one or more remote terminal units (RTUs) associated with the one or more industrial machines; integrate, using the set of one or more processors, the external contextual data with the monitoring data to form a combined display of the external contextual data and the monitoring data; provide data that visually associates the external contextual data and the one or more alarms in the combined display; and thereafter communicate a control instruction to the one or more industrial machines, via the one or more RTUs, the control instruction configured to change the state of the one or more industrial machines to address the one or more alarms.

The foregoing is a summary and is not intended to be in any way limiting. For a better understanding of the example embodiments, reference can be made to the detailed description and the drawings. The scope of the invention is defined by the claims.

### BRIEF DESCRIPTION OF THE SEVERAL VIEWS OF THE DRAWINGS

FIG. 1 illustrates an example method according to an embodiment.

FIG. 2 illustrates an example network of industrial machines according to an embodiment.

FIG. 3 illustrates an example tracking interface according to an embodiment.

FIG. 4 and FIG. 4A illustrate an example combined display according to an embodiment.

FIG. 5 illustrates an example dashboard according to an embodiment.

FIG. 5A, FIG. 5B, and FIG. 5C illustrate example dashboard components according to an embodiment.

FIG. 6 illustrates an example control workflow according to an embodiment.

FIG. 7 illustrates an example system according to an embodiment.

### DETAILED DESCRIPTION

It will be readily understood that the components of the embodiments, as generally described and illustrated in the figures herein, may be arranged and designed in a wide variety of ways in addition to the examples described herein. The detailed description uses examples, represented in the figures, but these examples are not intended to limit the scope of the claims.

Reference throughout this specification to “embodiment(s)” (or the like) means that a particular described feature or characteristic is included in that example. The described feature or characteristic may or may not be claimed. The described feature may or may not be relevant to other embodiments. For the purpose of this detailed description, each example might be separable from or combined with another example, i.e., one example is not necessarily relevant to other examples, but combinations of embodiments are expected in some cases consistent with the examples described throughout.

Therefore, the described features or characteristics of the examples generally may be combined in any suitable manner, although this is not required. In the detailed description, numerous specific details are provided to give a thorough understanding of example embodiments. One skilled in the relevant art will recognize, however, that the claims can be practiced without one or more of the specific details found in the detailed description, or the claims can be practiced with other methods, components, etc. In some instances, well-known details are not shown or described to avoid obfuscation.

The various described embodiments provide or operate in conjunction with a supervisory control and data acquisition (SCADA) system, which may be implemented at least in part by a cloud computing device or other server device, which includes logic and processing of a centralized control and display system as described throughout. In an embodiment, a combined display is provided featuring external contextual data, i.e., off-platform or third-party data such as radar data obtained from an external weather service, along with graphical indications of a set of industrial machines being monitored and controlled. The integration of external contextual data into the combined display facilitates visualization of monitored and controlled industrial machines along with relevant external contextual data, such as animated weather data (e.g., radar data), static weather data (e.g., weather alerts, watches, or warnings), or a combination of the foregoing.

In an embodiment, external contextual data may be utilized in one or more control workflows, for example to assist in control automation that is orchestrated based at least in part on the external contextual data. For example, weather data may indicate an approaching or recent historical storm, which is correlated and visually associated with alarm data from monitored and controlled industrial machines. This permits a human operator to quickly distinguish between likely categories of events that have occurred or that are projected to occur, such as alarms that will be or have been caused by, or are related to, an anticipated or historical storm event. Accordingly, an embodiment may be utilized to incorporate this information into analytics, reports, and control workflow automations to assist human operators and field technicians in planning, maintenance and the like.

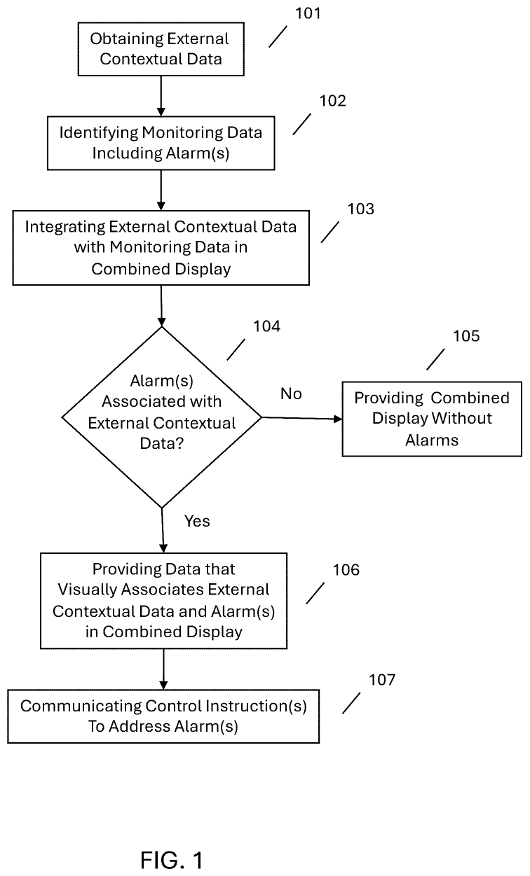

Referring to FIG. 1, an embodiment provides a method for controlling one or more industrial machines based on external contextual data and monitoring data of a SCADA system. As indicated, an embodiment may obtain, for example using an application programming interface (API), external contextual data from one or more external sources at 101. For example, an embodiment may utilize an API to one or more external sources of contextual data relevant to the SCADA system. By way of specific example, a SCADA system utilized for controlling a geographically distributed set of industrial machines such as water collection or wastewater treatment industrial machines that span multiple counties or states may utilize contextual data comprising weather data. For example, the external source from which data is obtained at 101 may include the National Weather Service or similar provider of weather radar data indicating precipitation and various weather advisory data such as weather alerts, weather watches, weather warnings, and similar advisories.

As illustrated, the method may include identifying, using a set of one or more processors, for example of a cloud computing device or central controller of a SCADA system, monitoring data comprising one or more alarms obtained from one or more remote terminal or telemetry units (RTUs) associated with the one or more industrial machines at 102. By way of example, the identifying of monitoring data may include selecting, based at least in part on the external contextual data, a subset of the one or more industrial machines. The selection of a set of one or more industrial machines may be performed manually, for example via interacting with a user interface (UI). The selection of a set of one or more industrial machines may be performed automatically, for example as the result of configuration or programming that logically associates industrial machines, monitoring data, contextual data, or some combination thereof, using a programmed factor, such as geographic proximity, proximity in time, a manual selection, a combination thereof, etc.

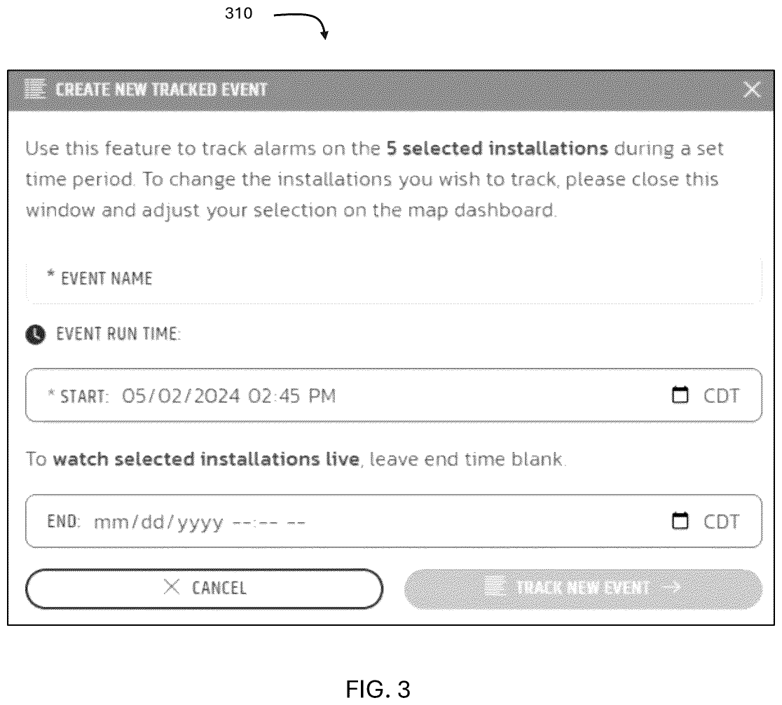

The selection of a set of one or more industrial machines may be performed in a semi-automated way, for example using a combination of user configurations or other manual inputs such as selections along with programming, for example use of a tracking program as described herein in connection with FIG. 3. By way of example, the selecting of one or more industrial machines may include associating a geographic location of the one or more alarms of the monitoring data with a geographic location associated with the external contextual data. For example, an association by be determined using a proximity threshold, allowing alarms to be linked to the contextual data obtained from the external system. Other data types may also be included, for example time, to allow projections as to if and when alarms were associated with external data such as weather data or are expect to be associated therewith. Such determinations or projections may be included in a workflow, for example an automated notification to service technicians regarding an expected set of alarms, alarm types, etc., associated with an upcoming storm, a historical report and categorization thereof, or the like. This may allow for intelligent orchestration of alarm management, industrial machine control, etc. For example, a workflow may be configured to track a set of industrial machines and/or a weather event, providing sets of alarms, industrial machines, or both as outputs, for example as a report generated to a human operator reviewing historical alarm data along with categorizations of the alarms based on historical weather data, an advisory message to a field technician of expected alarm types in a geographic region based on upcoming or expected storm data, a control instruction that operates industrial machine(s) in response to or in anticipation of a weather event, such as opening a water valve in expectation of rising water levels from a storm, etc.

Accordingly, in an embodiment the method includes integrating at 103 the external contextual data with the monitoring data to form a combined display of the external contextual data and the monitoring data. In the example of external contextual data obtained from a weather service, the integrating may include overlaying or otherwise combining the data with other external data, such as map data, to form a static or dynamic animation that progresses over time as one or more of the external contextual data, the monitoring data, or both changes.

Referring to FIG. 1, an embodiment may determine that alarms are associated with external contextual data, for example based on proximity, as indicated at 104. As with other functionality, the process of determining may be based on manual review, semi-automated, or fully automated, or a combination of the foregoing. If no alarms are determined, an embodiment may provide a combined display without alarm data, such as displaying monitored installations or industrial machines combined with weather data, as indicated at 105. In an embodiment, responsive to determining one or more alarms, a method may include providing data that visually associates the external contextual data and the one or more alarms in the combined display, as indicated at 106. For example, a map view may be automatically combined with monitoring data and external contextual data to produce an animation to associate industrial machines, alarms emanating therefrom, and weather data such as radar or storm watches in a graphical user interface, as further described herein.

Thereafter, in an embodiment, a method may include communicating a control instruction to the one or more industrial machines via the one or more RTUs, as indicated at 107. For example, a control instruction may be determined by a cloud control processor of the SCADA system, for example, to open a valve, operate a pump, etc., in response to monitoring data returned by an RTU, such as data of a flow sensor, a water level sensor, etc. In an embodiment, such a control instruction may be determined at least in part based on the external contextual data, e.g., an anticipated storm is projected to create flooding in a certain county based on a flood warning, where the control instruction changes states of pumps and valves from off to on and closed to open, respectively, in advance of the approaching storm. In an embodiment, type and/or timing associated with a control instruction may be determined based on the external contextual data, e.g., using the rate of an approaching storm compared with the distance to a monitored industrial machine, an expected water level rise rate, etc., to select a type of control (such as valve open) and timing thereof (e.g., in one hour, for four hours or until manually reset, etc.). Similarly, reporting or advisory instructions may be sent to field technicians with appropriate data and timing based on external contextual data, etc. Therefore, in an embodiment the control instruction is configured to change the state of the one or more industrial machines to address the one or more alarms, which may be predictive alarms calculated based at least in part on external contextual data, for example opening a valve or turning on a pump from an off state in response to an expected or received high water level sensor reading, etc.

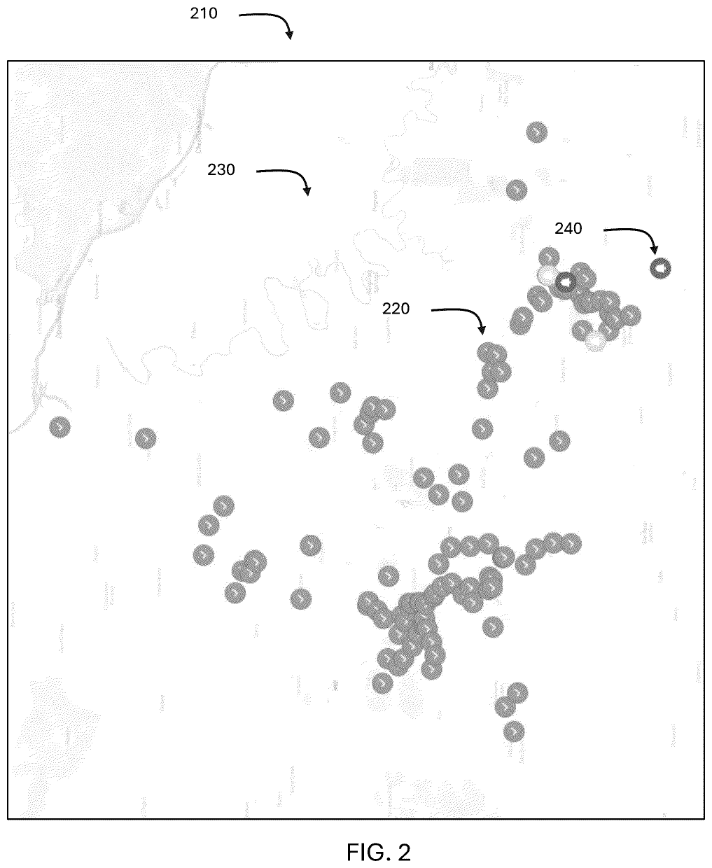

Referring to FIG. 2, and embodiment provides a graphical user interface (GUI) 210 in which a user may view and interact with map data 230 including monitored industrial machines and associated alarm indicators, for example indicated at 220 and 240, respectively. Monitored industrial machines 220 may be visually distinguished, for example via use of different color of UI elements based on machine state for various industrial machines 220, 240. It is noted that an indication, e.g., 220, 240, in GUI 210 may include a plurality of industrial machines and device or sensor types, for example indication 220 may comprise an entire wastewater treatment facility with various associated industrial machines that can generate alarms. The granularity of the data in GUI 210 may change, e.g., based on zoom level. Monitored industrial machines 220 may be selected for placement in interface 210 via a manual, semi-automated, or automated process, as described herein.

By way of example, and referring to FIG. 3, a user may interact with a GUI in the form of a tracking UI element 310 for configuring a tracking event for a subset of one or more industrial machines. For example, a user may engage with tracking UI element 310 to manually select or highlight a set of industrial machines, for example 5 installations selected from map view 230, which are to be tracked for a given time frame, for example with a defined starting time, a defined end time, or for an open ended time. This process may be done for example in advance of an anticipated storm event, as part of a programmed schedule, etc., In an embodiment, the selection process may be automated or semi-automated. For example, an embodiment may accept a program configured by a user to monitor all industrial machines at installations as a logic group based on external contextual data, such as included in a geography associated with a weather advisory, within proximity to a type of radar data, etc., which acts as a trigger or starting condition of a workflow. The selecting of the industrial machines identifies these as a subset of industrial machines which are logically associated with the tracking event, for example collected into an event UI, as further described herein. The tracking event therefore may include a time window during which the subset of industrial machines is tracked in association with external contextual data, such as a weather event, e.g., a storm indicated by radar data, a flood advisory event for a given county, etc.

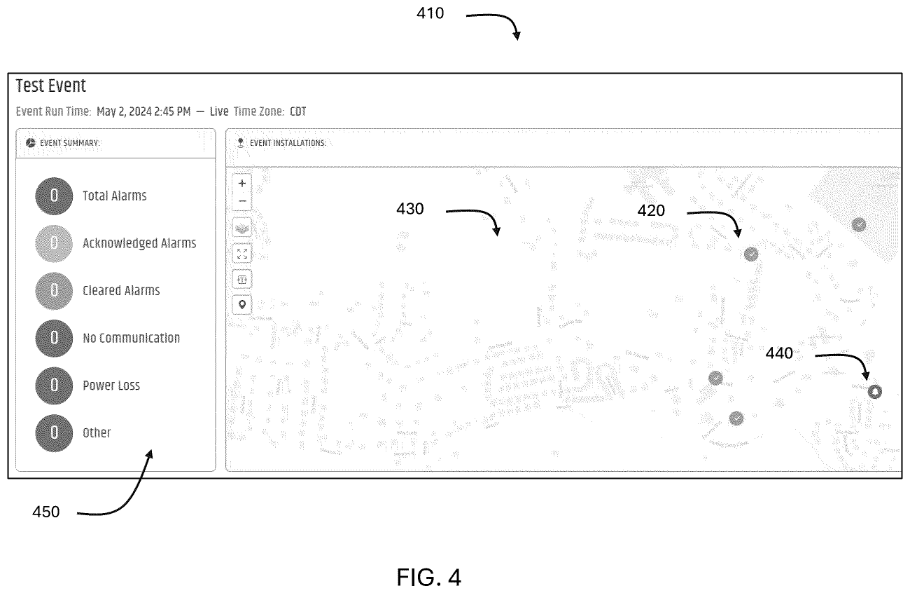

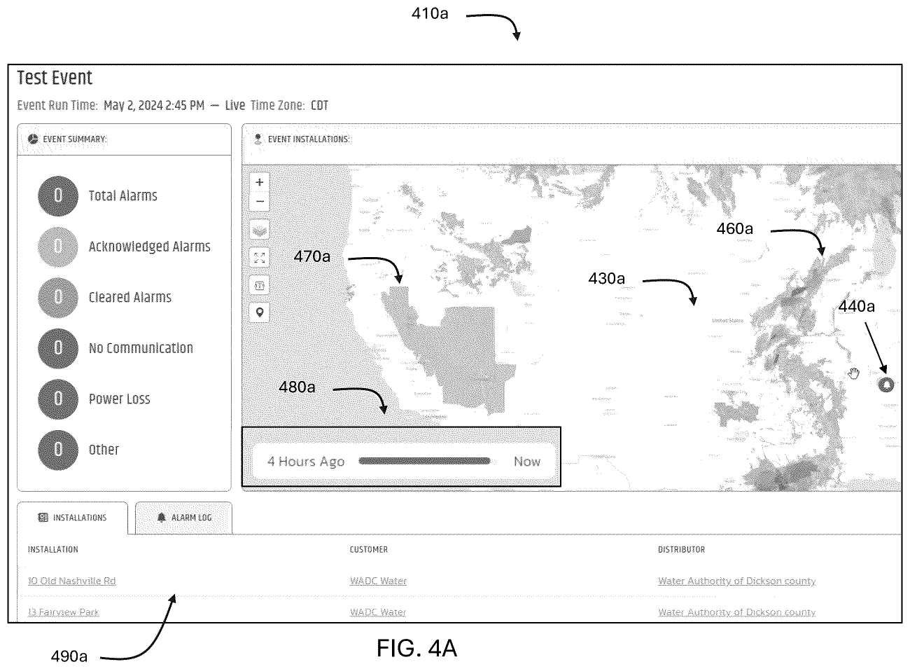

FIG. 4 and FIG. 4A illustrate an example combined display according to an embodiment. In the view illustrated in FIG. 4, a GUI 410 provides an interactive combined display in which data such as map data 430 and monitoring data 420, 420 is provided. As with FIG. 2, the indications of monitoring data 420, 440 of industrial machines (or installations sites) may be visually or otherwise distinguished, for example using different colors to distinguish alarm and normal monitoring data. The types or categories of monitoring data may be provided in a graphic or legend 450, as indicated.

Illustrated in FIG. 4A is a view in which map data 430a is associated with monitoring data 440, like that shown in FIG. 4. However, FIG. 4A has been zoomed out, for example via user manual input, to illustrate that there are various types of external contextual data 460a, 470a, included in the combined display of GUI 410a. Map data 430a is overlaid with external contextual data 460a in the form of radar data, which for example is provided as an animation along a predetermined time as shown at 480a, noting that the predetermined time may be programmatically determined or changed, for example via a determination formed from a tracking program or workflow. By way of example, the predetermined time of the animation may be altered based on a look ahead period configured in the tracking program, allowing for radar or various other types of external contextual data projections to be included in combined display for a tracked set of industrial machines. Further, weather data 470a is also provided, in this example as weather advisory data (e.g., watches, warnings, alerts) associated with map data in the form of counties or other geographic jurisdictional boundaries, as per the external contextual data service.

Also shown in the combined display of FIG. 4A is monitoring data 490a, which presents categorized types of monitoring data, for example organizing alarms into a tabbed section of the UI that visually associates the monitoring data, such as alarms, with the external contextual data, such as weather data animated or provided in a map view associated with monitored geographically dispersed industrial machines. Thus, GUI 410a permits a user to readily access alarms reported from the monitored subset of industrial machines configured to be tracked using a tracking program. The facilitates threshold or other automation-based workflows, for example sending an alert message to a field technician once a predetermined percentage of the tracked installations are in an alarm state, etc. Likewise, control instructions for operating the industrial machines may also be coordinated or orchestrated in a manual, semi-automated, or automated fashion using such data as an input. By way of example, a user may configure a tracking and/or control program to monitor a set of tracked industrial machines in relation to a storm event. As such, historical and/or projected storm data from an external contextual data source may supply the user with advanced notice and ongoing context of the storm's expected impact on alarm states of monitored industrial machines. For example, a workflow configured by a user may issue notifications to field technicians once a first threshold of industrial machines is impacted in the alarm state or projected to be in an alarm state, and issue control instructions to industrial machines once a second, higher threshold of industrial machines is or is expected to be in an alarm state, for example to mitigate rising or expected flood water due to a storm.

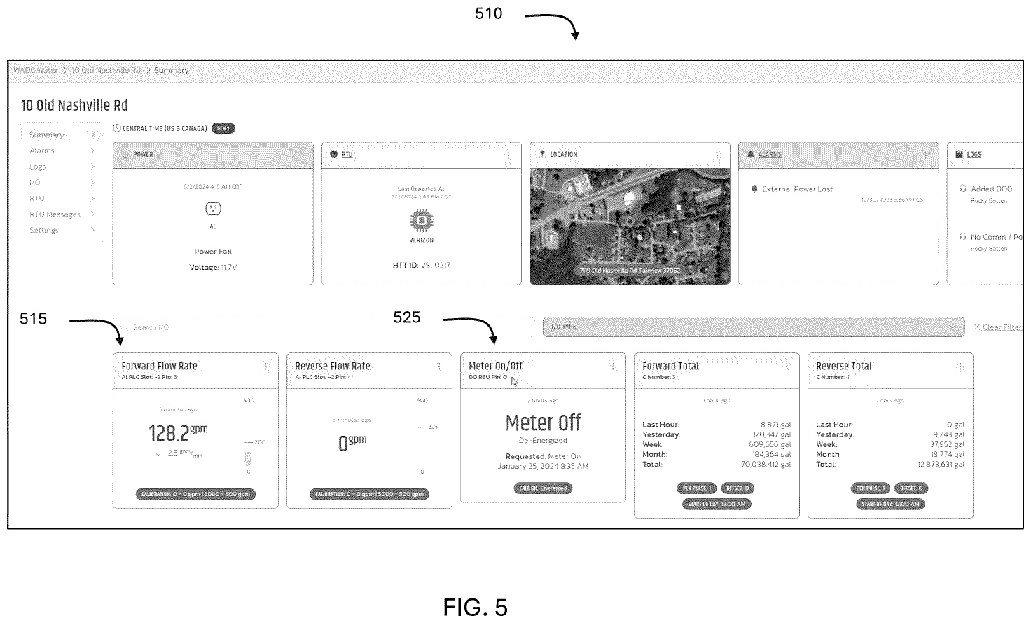

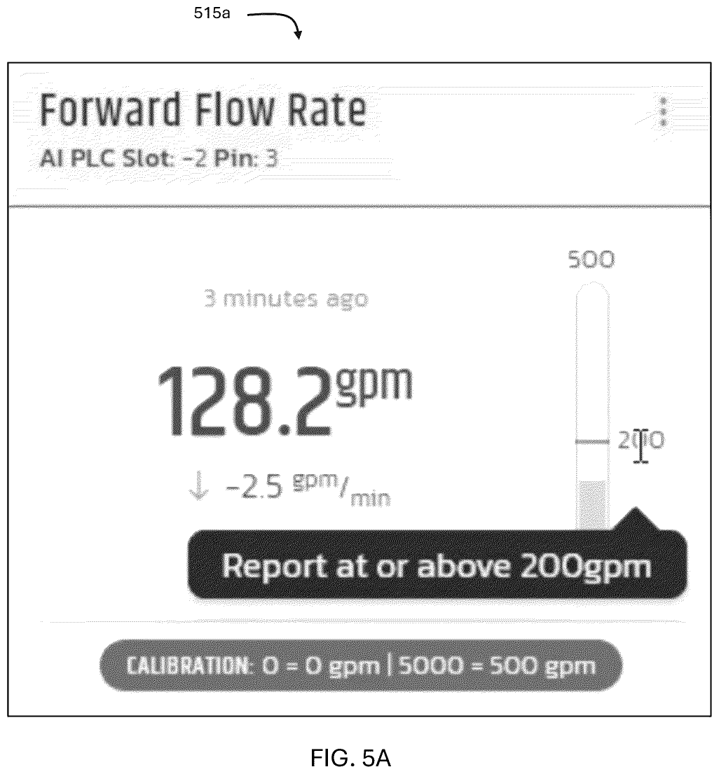

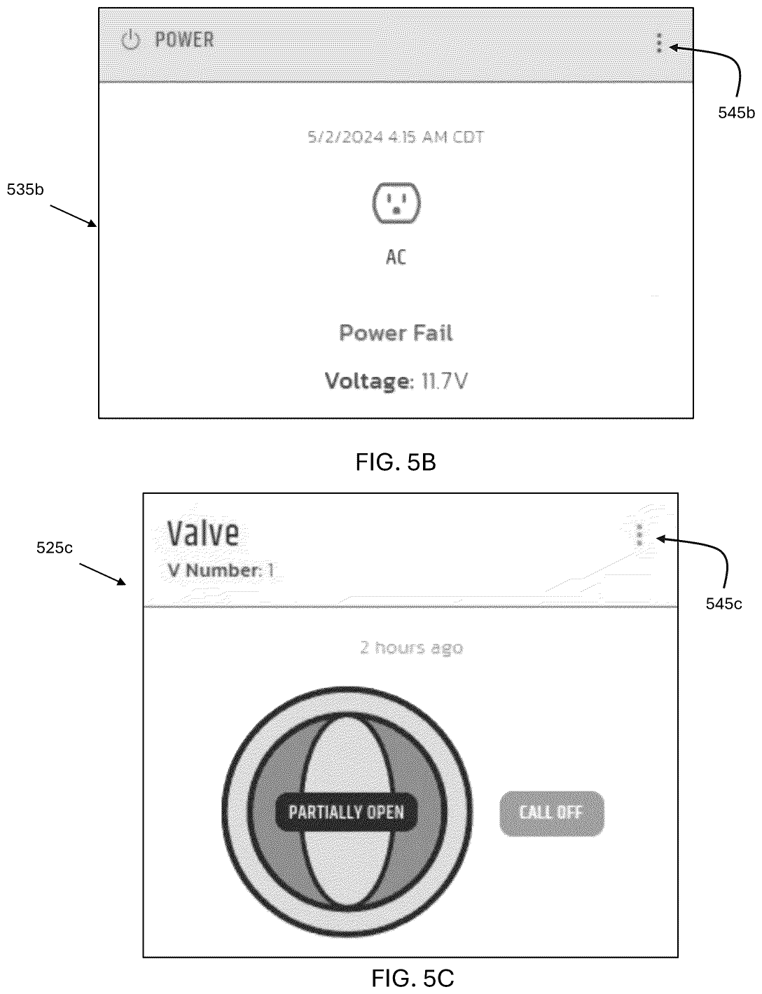

Turning to FIGS. 5, 5A, 5B, and 5C, illustrated are examples of a dashboard and dashboard components or objects according to an embodiment. In an embodiment, the platform presents, for example via a web browser program used to provide views in FIGS. 2, 3, 4, and 4A, a view as illustrated in FIG. 5 in which a dashboard 510 having components or objects such as 515 and 525. This permits a user to view monitoring data and control information using dashboard 510. Further, components 515 and 525 are interactive and may be used to view, edit or create control workflows, notification or alarm settings, etc., as described herein. In the example of FIG. 5, dashboard component 515 provides monitoring data related to a water flow sensor for a water collection installation in the form of an interactive card. Dashboard component 525 illustrates monitoring data indicative of the state of an industrial machine in the nature of a meter.

Shown in FIG. 5A is an enlarged view 515a of dashboard component 515. Here, the monitoring data provides information related to a water flow sensor and related control program associated therewith, i.e., report at or above a flow rate of 200 gallons per minute (gpm). The monitoring data may be utilized, for example by a human reviewer or a control program automation, to ascertain whether the flow rate is acceptable or predicted to be so in view of the contextual data, e.g., a storm projection or flood advisory for the geographic location associated with the flow sensor's geographic location.

FIG. 5B and FIG. 5C provide further examples of dashboard components. FIG. 5B illustrates dashboard component 535b, which indicates a control state (power failure) and error type (AC power failure) for a monitored industrial machine. As indicated, a user may interact with dashboard component 535b as an interactive card object, as indicated by interactive element 545b, to obtain further data and input control configurations, for example attempt to power cycle the industrial machine, etc.

FIG. 5C provides a view of example dashboard component 525c, which displays the operational state of a valve as partially open. As with other industrial machines, valve represented by dashboard component 525c may be controlled in a manual, semi-automated, or automated fashion, for example based at least in part on external contextual data. For example, a user may manually review a combined display such as illustrated in FIG. 4A that provides external contextual data combined with alarm data to determine a need to fully open the valve represented by dashboard component 525c and use, for example, interactive element 545c to open a GUI pane to implement such a control instruction manually. Likewise, a control program may take as output data of a tracking program, for example a threshold number n of alarm states has been reached with a geographic center estimate of a storm also being within a threshold m to instruct the valve represented by dashboard element 525c to open fully for a predetermined time, e.g., a water level or flow being lower than a certain threshold x for a predetermined time y. Other combinations or workflow conditions are possible as would be appreciated by reviewing the contents of this disclosure.

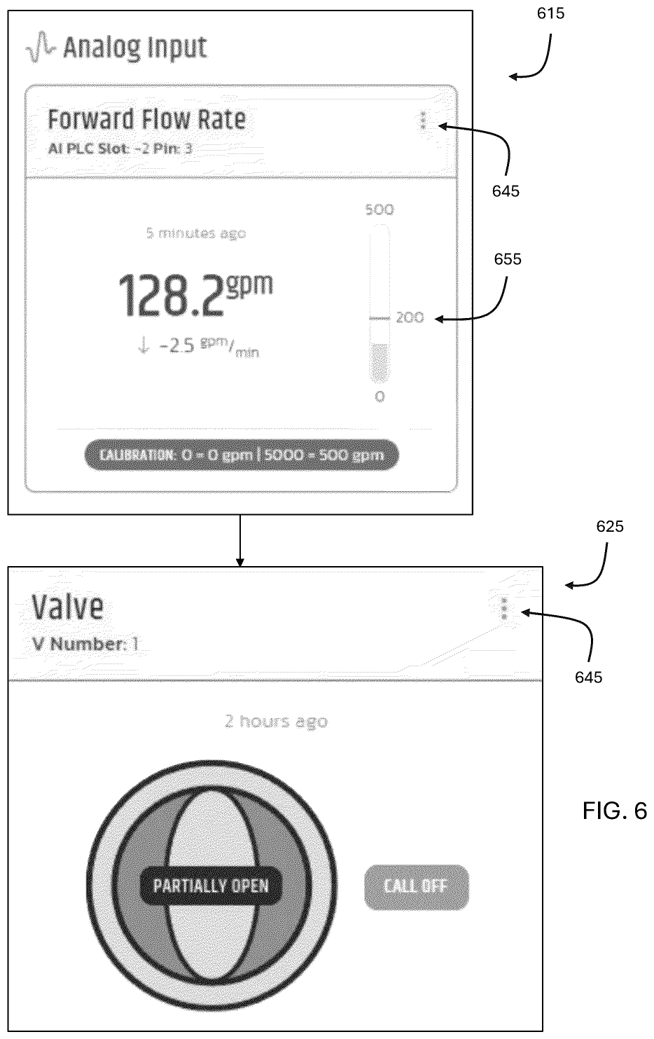

By way of example, FIG. 6 illustrates an example control workflow according to an embodiment. Here, a first 615 and a second 625 dashboard components or objects are connected logically in order, for example in a workflow designer provided by an embodiment. In a first case, an analog input such as flow rate of a monitored industrial machine (i.e., flow rate sensor) represented by dashboard component 615 is used along with a threshold 655 of 200 gmp to determine a condition of a workflow. In this example, the workflow conditions a valve's operational state, as represented by dashboard component 623. As may be appreciated, logic and instructions may be entered by the user as configuration parameters, for example entered via interacting with an interaction element of each dashboard 615, 625, collectively indicated at 645. For example, a user may interact with dashboard component 615 to set a threshold, e.g., threshold 655, and related outputs. Similarly, a user may interact with dashboard component 625 to set an operational state dependent on an input received. A user may link or associate one dashboard's output with another's input in a flow designer, for example using a graphical or low code programming interface that permits graphical element linkages to be converted into coded instructions of a control program, as indicated by the connecting arrow of FIG. 6.

An embodiment therefore facilitates the orchestration of industrial machines by providing more comprehensive external contextual data to a SCADA system. In an embodiment, the external contextual data is combined with industrial machine monitoring data to provide improved combined displays for reviews. In an embodiment, the external contextual data may also be utilized to further automate certain controls of the monitored industrial machines, including at least providing additional input to workflows such as reporting, alerting and controlling workflows associated with a tracked set of industrial machines.

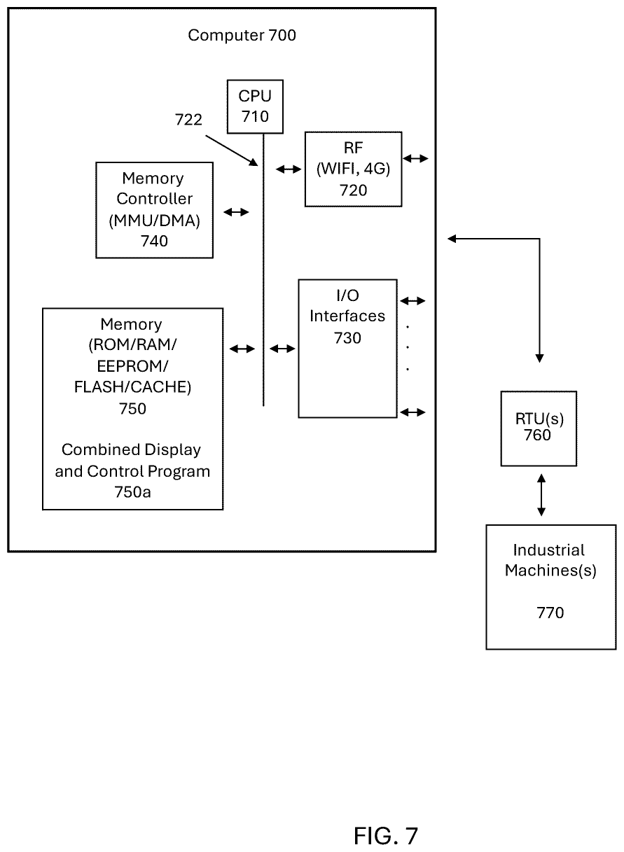

It will be readily understood that certain embodiments can be implemented using any of a wide variety of devices or combinations of devices. Referring to FIG. 7, an example device that may be used in implementing one or more embodiments includes a computing device (computer) 700, for example included in or operatively coupled to a cloud server of a SCADA system or component thereof.

The computer 700 may execute program instructions or code configured to capture, store, and process data, e.g., monitoring data and external contextual data from an RTUs and external source APIs such as one or more weather services, map services, etc., as described herein, and perform other functionality of the embodiments. Components of computer 700 may include, but are not limited to, a processing unit 710, which may take a variety of forms such as a central processing unit (CPU), a graphics processing unit (GPU), a combination of the foregoing, etc., a system memory controller 740 and memory 750, and a system bus 722 that couples various system components including the system memory 750 to the processing unit 710. The computer 700 may include or have access to a variety of non-transitory computer readable media. The system memory 750 may include non-transitory computer readable storage media in the form of volatile and/or nonvolatile memory devices such as read only memory (ROM) and/or random-access memory (RAM). By way of example, and not limitation, system memory 750 may also include an operating system, application programs, other program modules, and program data. For example, system memory 750 may include combined display and control programs as described herein. Data may be transmitted by wired or wireless communication, e.g., to or from computer 700 to another device, e.g., RTUs 760 and/or industrial machines 770.

A user can interface with (for example, enter commands and information) the computer 700 through input devices such as a touch screen, keyboard, keypad, etc. A monitor or other type of display screen or device can also be connected to the system bus 722 via an interface, such as interface 730. The computer 700 may operate in a networked or distributed environment using logical connections to one or more other remote computers or databases. The logical connections may include a network, such local area network (LAN) or a wide area network (WAN) but may also include other networks/buses.

It should be noted that various functions described herein may be implemented using processor executable instructions stored on a non-transitory storage medium or device. A non-transitory storage device may be, for example, an electronic, electromagnetic, or semiconductor system, apparatus, or device, or any suitable combination of the foregoing. More specific examples of a non-transitory storage medium include the following: a portable computer diskette, a hard disk, a random-access memory (RAM), a read-only memory (ROM), an erasable programmable read-only memory (EPROM or Flash memory), a portable compact disc read-only memory (CD-ROM), a solid-state drive, or any suitable combination of the foregoing. In the context of this document “non-transitory” media includes all media except non-statutory signal media.

Program code embodied on a non-transitory storage medium may be transmitted using any appropriate medium, including but not limited to wireless, wireline, optical fiber cable, RF, etc., or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN) or the connection may be made through other devices (for example, through the Internet using an Internet Service Provider), through wireless connections, or through a hard wire connection, such as over a USB or another power and data connection.

Example embodiments are described herein with reference to the figures, which illustrate various example embodiments. It will be understood that the actions and functionality may be implemented at least in part by program instructions. These program instructions may be provided to a processor of a device to produce a special purpose machine, such that the instructions, which execute via a processor of the device implement the functions/acts specified.

It is worth noting that while specific elements are used in the figures, and a particular illustration of elements has been set forth, these are non-limiting examples. In certain contexts, two or more elements may be combined, an element may be split into two or more elements, or certain elements may be re-ordered, re-organized, combined or omitted as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method for controlling one or more industrial machines based on external contextual data and monitoring data of a supervisory control and data acquisition (SCADA) system, comprising:
obtaining, using an application programming interface (API), the external contextual data from one or more external sources;
identifying, using a set of one or more processors, monitoring data comprising one or more alarms obtained from one or more remote terminal units (RTUs) associated with the one or more industrial machines;
integrating, using the set of one or more processors, the external contextual data with the monitoring data to form a combined display of the external contextual data and the monitoring data;
providing data that visually associates the external contextual data and the one or more alarms in the combined display; and
thereafter communicating a control instruction to the one or more industrial machines, via the one or more RTUs, the control instruction configured to change the state of the one or more industrial machines to address the one or more alarms.

2. The method of claim 1, wherein the external contextual data is weather data comprising one or more of radar data, geographic weather advisory data, geographic weather alert data, and geographic weather watch data.

3. The method of claim 2, wherein the integrating comprises generating an animation comprising the radar data and map data associated with a geographic location of the one or more alarms.

4. The method of claim 2, wherein the integrating comprises generating an image comprising one or more of:
the geographic weather advisory data, geographic weather alert data, and geographic weather watch data; and
map data associated with a geographic location of the one or more alarms.

5. The method of claim 1, wherein:
the integrating comprises providing alarm data obtained from the one or more RTUs in a user interface element of the combined display; and
the alarm data indicates an association of the one or more alarms with the external contextual data.

6. The method of claim 1, comprising providing a tracking user interface element for configuring a tracking event for a subset of the one or more industrial machines;
the tracking event comprising a time window during which the subset is tracked in association with external contextual data.

7. The method of claim 1, wherein the identifying comprises selecting, based at least in part on the external contextual data, a subset of the one or more industrial machines.

8. The method of claim 7, wherein the selecting comprises associating a geographic location associated with the one or more alarms with a geographic location associated with the external contextual data.

9. The method of claim 1, comprising changing the state of the one or more industrial machines to address the one or more alarms.

10. The method of claim 9, comprising determining, based at least in part on a projection derived from the external contextual data, that a control workflow condition is satisfied;
wherein the changing comprises altering the state of the one or more industrial machines to address one or more projected alarms.

11. A system for controlling one or more industrial machines based on external contextual data and monitoring data of a supervisory control and data acquisition (SCADA) system, comprising:
a set of one or more processors; and
a non-transitory storage medium comprising code executable by the set of one or more processors to:
obtain, using an application programming interface (API), the external contextual data from one or more external sources;
identify, using the set of one or more processors, monitoring data comprising one or more alarms obtained from one or more remote terminal units (RTUs) associated with the one or more industrial machines;
integrate, using the set of one or more processors, the external contextual data with the monitoring data to form a combined display of the external contextual data and the monitoring data;
provide data that visually associates the external contextual data and the one or more alarms in the combined display; and
thereafter communicate a control instruction to the one or more industrial machines, via the one or more RTUs, the control instruction configured to change the state of the one or more industrial machines to address the one or more alarms.

12. The system of claim 11, wherein the external contextual data is weather data comprising one or more of radar data, geographic weather advisory data, geographic weather alert data, and geographic weather watch data.

13. The system of claim 12, wherein to integrate comprises generating an animation comprising the radar data and map data associated with a geographic location of the one or more alarms.

14. The system of claim 12, wherein to integrate comprises generating an image comprising one or more of:
the geographic weather advisory data, geographic weather alert data, and geographic weather watch data; and
map data associated with a geographic location of the one or more alarms.

15. The system of claim 11, wherein:
to integrate comprises providing alarm data obtained from the one or more RTUs in a user interface element of the combined display; and
the alarm data indicates an association of the one or more alarms with the external contextual data.

16. The system of claim 11, wherein the non-transitory storage medium comprises code executable by the set of one or more processors to provide a tracking user interface element for configuring a tracking event for a subset of the one or more industrial machines;
the tracking event comprising a time window during which the subset is tracked in association with external contextual data.

17. The system of claim 11, wherein to identify comprises selecting, based at least in part on the external contextual data, a subset of the one or more industrial machines.

18. The system of claim 17, wherein the selecting comprises associating a geographic location associated with the one or more alarms with a geographic location associated with the external contextual data.

19. The system of claim 11, wherein the non-transitory storage medium comprises code executable by the set of one or more processors to change the state of the one or more industrial machines to address the one or more alarms.

20. A computer program product for controlling one or more industrial machines based on external contextual data and monitoring data of a supervisory control and data acquisition (SCADA) system, comprising:
a non-transitory computer readable medium comprising code executable by a set of one or more processors to:
obtain, using an application programming interface (API), the external contextual data from one or more external sources;
identify, using the set of one or more processors, monitoring data comprising one or more alarms obtained from one or more remote terminal units (RTUs) associated with the one or more industrial machines;
integrate, using the set of one or more processors, the external contextual data with the monitoring data to form a combined display of the external contextual data and the monitoring data;
provide data that visually associates the external contextual data and the one or more alarms in the combined display; and
thereafter communicate a control instruction to the one or more industrial machines, via the one or more RTUs, the control instruction configured to change the state of the one or more industrial machines to address the one or more alarms.
